(19) United States
(12) Patent Application Publication
(10) Pub. No.: US 2009/0106237 A1
(43) Pub. Date: Apr. 23, 2009

(54) SYSTEM AND METHOD FOR DYNAMICALLY CUSTOMIZING WEB PAGE CONTENT

(75) Inventors: Paul Holstein, Pompano Beach, FL (US); Daniel Shields, Boca Raton, FL (US); Nicolas Dubus, Fort Lauderdale, FL (US)

Correspondence Address: PEPPER HAMILTON LLP, ONE MELLON CENTER, 50TH FLOOR, 500 GRANT STREET, PITTSBURGH, PA, 15219, US

(73) Assignee: CABLEORGANIZER.COM INC., Fort Lauderdale, FL (US)

(21) Appl. No.: 12/250,196

(22) Filed: Oct. 13, 2008

Related U.S. Application Data
(60) Provisional application No. 60/979,716, filed on Oct. 12, 2007.

(51) Int. Cl. G06F 7/06; G06F 17/30

(52) U.S. Cl. 707/5; 707/E17.108

(57) ABSTRACT

A method for providing customized web page content. The method includes receiving information from a referring uniform resource locator (URL) including information relating to a first search performed by a user, processing specific terms in the referring URL to produce a customized web page based upon the terms in the referring URL, and presenting the customized web page to the user.

### RELATED APPLICATIONS AND CLAIM OF PRIORITY

This application claims the priority benefit of U.S. Provisional Application No. 60/979,716 filed Oct. 12, 2007 which is hereby incorporated by reference.

NOT APPLICABLE

### BACKGROUND

The present invention relates to the creation of dynamic content for customizing web pages, and, more specifically, to dynamically customizing web page content based on analysis of a referring uniform resource locator (URL).

As the Internet has expanded, so too have commercial applications of the Internet. One of these commercial applications is consumer commerce. Many vendor web sites are devote either partially or entirely toward selling products or services to consumers. Many of these vendor web sites cover a wide range of products, e.g., DVDs, CDs, books, video games, electronics, etc. In order to quickly sort available products and services, many web sites include an internal search engine that provides a means for a user to enter specific terms into the search engine and search the vendors site for a desired product.

However, before having the option to search for or purchase a product at a specific vendor web site, a user must direct their browser to the web site. This is done by either entering the URL of the web site directly into the browser or, more commonly, using an Internet search engine to locate and direct the user's browser to a specific web site.

This common procedure creates a redundancy in the search process for many users. If a first time user is unaware of a particular web site selling their desired goods, or if a user is imply unaware of the URL of a vendor web site, the user may first use an available Internet search engine to locate the vendor web site, then use a vendor web site specific search engine to identify the individual desired product or products on the vendor web site itself. Thus, there exists a need for a system and method that eliminates the redundant searching by a user while still providing an accurate search of a vendor web site for any products desired by the user.

### SUMMARY

Before the present methods are described, it is to be understood that this invention is not limited to the particular systems, methodologies or protocols described, as these may vary. It is also to be understood that the terminology used herein is for the purpose of describing particular embodiments only, and is not intended to limit the scope of the present disclosure which will be limited only by the appended claims.

It must be noted that as used herein and in the appended claims, the singular forms “a,” “an,” and “the” include plural reference unless the context clearly dictates otherwise. Unless defined otherwise, all technical and scientific terms used herein have the same meanings as commonly understood by one of ordinary skill in the art. As used herein, the term “comprising” means “including, but not limited to.”

In one general respect, the embodiments disclose a method for providing customized web page content. The method includes receiving information from a referring uniform resource locator (URL) including information relating to a first search performed by a user, processing specific terms in the referring URL to produce a customized web page based upon the terms in the referring URL, and presenting the customized web page to the user.

In another general respect, the embodiments disclose a method for providing customized web page content based upon automated analysis of a referring URL. The method includes the steps of receiving a referring URL including search terms relating to a first search performed by a user, extracting the search terms from the referring URL, searching a localized database for related information to the extracted search terms, producing a customized web page based upon the results of the searching a localized database, and presenting the customized web page to the user.

In another general respect, the embodiments disclose a system for providing customized web page content based upon automated analysis of a referring URL. The system includes various components, including a user computer configured to transmit a referring URL and a web server configured. The web server is configured to receive the referring URL including search terms relating to a first search performed by a user, extract the search terms from the referring URL, search a localized database for related information to the extracted search terms, produce a customized web page based upon the results of the searching a localized database, and transmit the customized web page to the user computer.

### BRIEF DESCRIPTION OF THE DRAWINGS

Aspects, features, benefits and advantages of the present invention will be apparent with regard to the following description and accompanying drawings, of which:

FIG. 1 illustrates various embodiments of a system for accessing a web server via a specific network;

FIG. 2 illustrates various embodiments of a method for searching for and receiving customized web sites; and

FIG. 3 illustrates a diagram of various web site views including customized search results.

### DETAILED DESCRIPTION

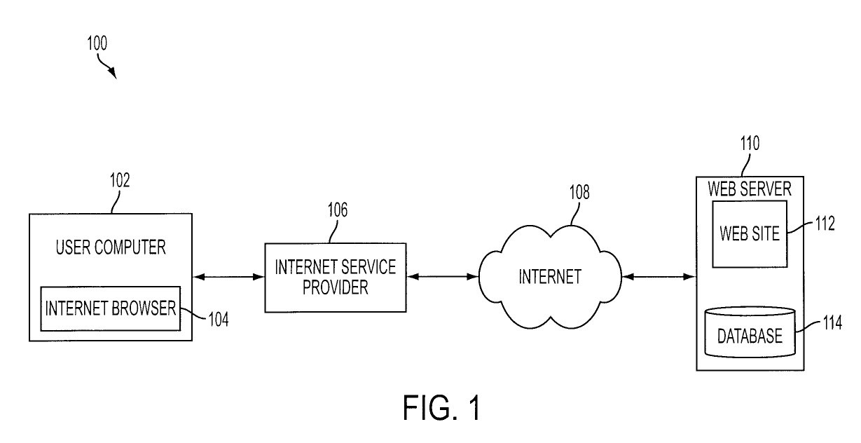

In accordance with various embodiments of the present invention, a customized vendor web site may be presented to a customer based upon the customer's search terms entered into a web based search engine, e.g., Google® or Yahoo!®, by capturing the input of the user into the search engine and process this input in an internal vendor web site search, thereby producing a set of results that may be used to construct a customized web site specifically based upon the customer's search terms. The various embodiments will be expanded upon as set forth in the following discussions of FIGS. 1-3.

FIG. 1 illustrates an exemplary network 100 that may be used by a customer to access the Internet in search of a specific product. The customer may access the network 100 by interacting with user computer 102. Installed on user computer 102 is Internet browser 104. Internet browser 104 is a software program installed on user computer 102 for communicating with a specific network via a dedicated gateway. In this example, Internet browser 104 communicates with Internet Service Provider (ISP) 106. ISP 106 acts as a gateway between user computer 102 and another network, in this example, Internet 108. ISP 106 receives instructions or requests from Internet browser 104 and forwards the instructions or requests as appropriate to Internet 108. Specialized routing web servers (not shown in FIG. 1) may further process these requests or instructions (collectively called a data flow), and directs the data flow to an appropriate web server for handling the instructions or request.

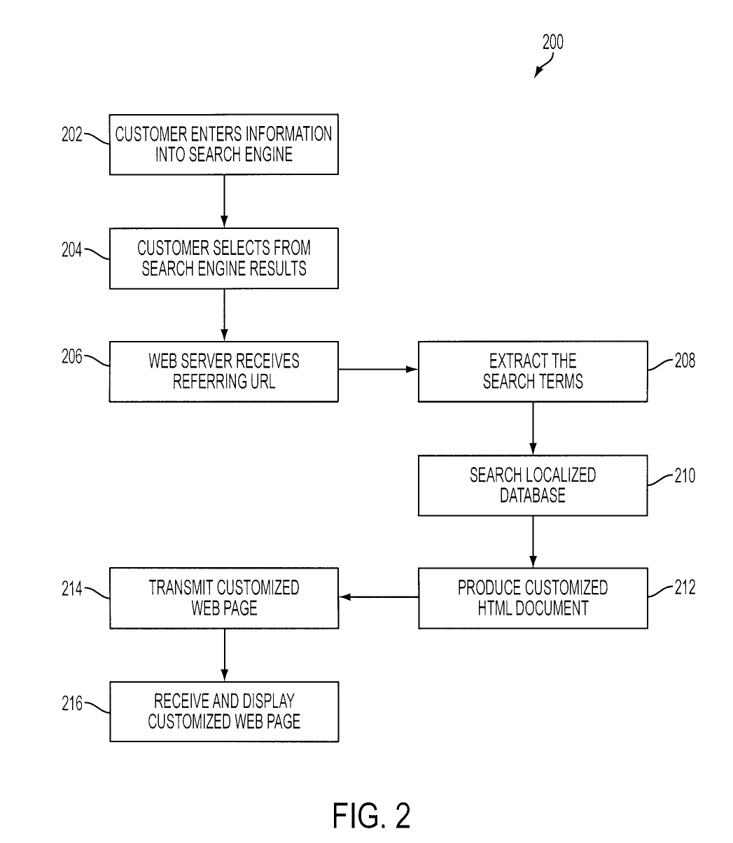

In FIG. 1, based upon the instructions or requests made by user computer 102, Internet browser 104 may be directed to information stored on web server 110, specifically web site 112 in order to construct and display a web page relating to the web site. In order to access web site 112 and construct the related web page, a hypertext markup language (HTML) document may be processed by Internet browser 104, and any items such as interactive content and graphics to be included in the web page may be loaded and presented to the customer using user computer 102. In the present application, any search terms entered by the customer at user computer 102 into a web based search engine being run by Internet browser 104 may be extracted and further processed by web server 110 to search database 114. Database 114 may be a specialized database containing information specific to web site 112 such as any products and services available through the vendor running web site 112. After searching database 114, web server 110 may return a customized HTML document to Internet browser 104 containing a modified version of web site 112, resulting in a customized web page based upon the initial search terms entered by a customer using user computer 102, thereby eliminating the need for a user to perform another search of web site 112 once the web site has loaded on the Internet browser. This process of creating and delivering customized web sites based upon user search terms entered into a web based search engine is described in greater detail below in the discussion of FIG. 2.

FIG. 2 illustrates an exemplary process 200 for performing various embodiments of the present invention, and expands upon the exemplary system and steps discussed above with regard to FIG. 1. Process 200 begins when a customer enters 302 information into a web based search engine such as Google®. A search is generally performed by a customer entering a word, phrase, set of specific search terms, or alphanumeric combination into a search field on the web based search engine and the search is executed. After the search is executed, the customer is presented with a search engine results page (SERP). The SERP presents the customer with organic, or natural search results, along with, in some instances, sponsored or paid for links. After entering 202 and performing the search, the customer selects 204 a link from the SERP.

A customer selects 204 a link by clicking on the link listed on the SERP. By clicking on the link, the Internet browser is directed to the URL of the selected link and, typically, the browser executes any code and functions in place on that selected web page. However, in the present invention, when a user selects 204 from the SERP, the referring URL from the web based search engine, containing the search terms the customer entered 202, is received 206 by the web server hosting the requested web site. After the web server receives 206 the referring URL, the web server extracts 208 the search terms from the URL. This extraction 208 may be done by including additional code on the web server dedicated to dissecting the referring URL and finding and isolating the terms that were used to present the SERP to the customer. Once the search terms are extracted 208, a localized database specific to the web site hosting the requested web page is searched 210. This search 210 is performed to identify any products, services, or additional pages present in the web site that may be of interest to the customer based upon the search terms.

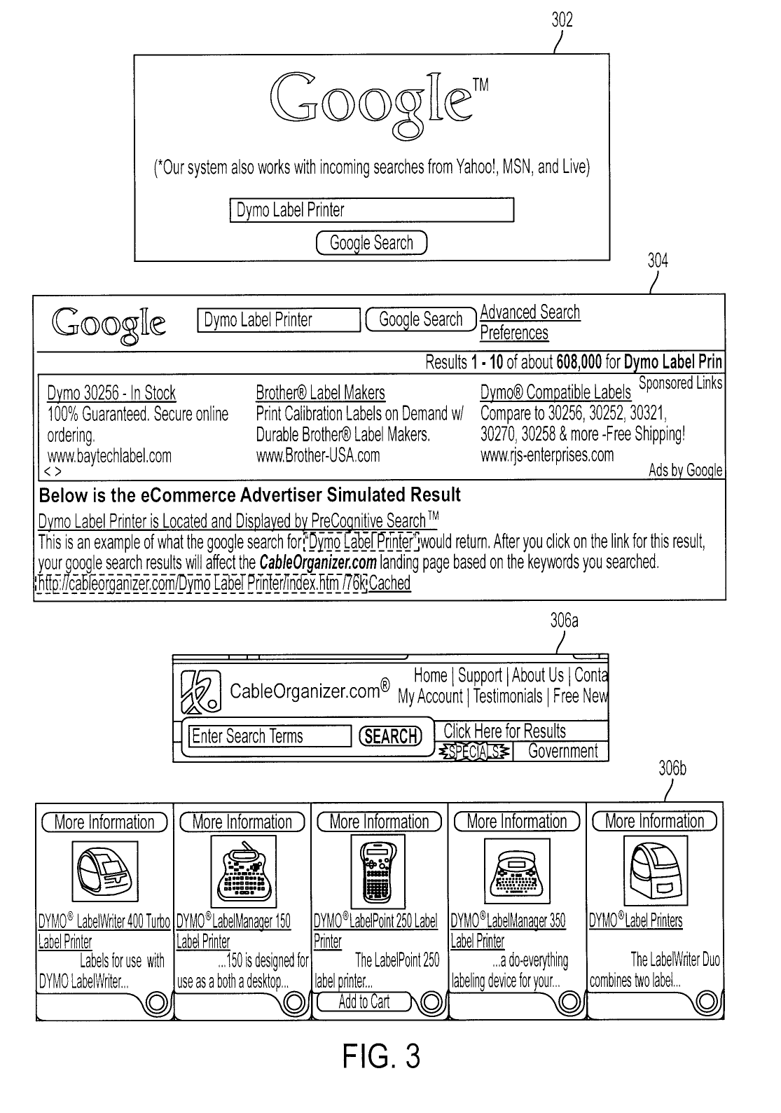

After searching 210 the database, a customized HTML document is produced 212. This document varies from the standard HTML document for the web page in that it includes any processed results of the database search, thereby resulting in a web page customized specifically for the customer. After producing 212 the customized HTML documents, and essentially the customized web page, the customized web page is transmitted 214 to the customer's Internet browser. As discussed before, after receiving the transmitted 214 HTML document, the Internet browser executes any code and functions in place on that selected web page. However, in this example, code and functions include instructions for displaying 216 the customized web page to the customer, including the results of the localized database search. Examples of specific features of the customized web page are expanded upon below in the discussion of FIG. 3.

FIG. 3 illustrates a diagram of several web site views or snapshots stepping through the process described above in the discussion of FIG. 2. Essentially, the diagram illustrates the steps as seen by a user, ignoring the processing being performed by the web server. Initially, in block 302, a user enters in several search terms into web based search engine, in this example, Google®. The search terms entered by the user in this example are “Dymo Label Printers”. The search engine then returns a list of results 304 (note, only a portion of the results are shown) including a link to a page on a web site that is implementing the customization method discussed above in FIG. 2. Upon selecting that link, the user is transitioned to the subject web page. Also, upon selecting the link, and unseen by the user, the web site analyzes the referring URL to determine the search terms submitted to the web based search engine, or in this example, “Dymo Label Printers”. Upon determination of the terms, the web site performs an internal database search and customizes the target web page based upon the internal search results.

Blocks 306a and 306b illustrate various examples of customization. Block 306a illustrates a dynamic link option where the user is presented with a link that will enter directly enter the search terms into a web site specific search engine. Block 306b illustrates a second customization option where the user is presented with a sample set of results (e.g., the top five results) from an internal search. By providing the user with at least two levels of customization, the user is given additional options of how to proceed. If the product the user desires is in the displayed sample set of results, the user may proceed directly to that page. If the desired item is not displayed in the search results, the user still has the option to perform an additional web site specific search for additional results above and beyond the results displayed in the sample set of results.

It will be appreciated that the embodiments discussed above are merely shown by way of example. The individual method steps and processes discussed above may be implemented in additional arrangements, such as a toolbar for use in a standard web based search engine. The toolbar may include a functionality for monitoring search terms entered into a web-based search engine, and extracting these search terms for producing customized content for individual web sites, including web sites not specifically configured to perform the above discussed methods and processes.

Additionally, this individual method steps and processes discussed above may also be implemented through a third party or “affiliate publisher” domain, or distributed to other outside domains. For example, a certain publisher may host the searching service along with the localized database for an individual website. This affiliate publisher would perform the search on the localized database and provide a web site with the results in response to a web search as discussed above. The web site may have access to the affiliate publisher, e.g. through a secure username/password login process, to update any searching criteria along with the localized database. Additionally, through a login process, uses may be able to provide opinions about services or goods they have received through the searching service to provide a level of feedback for additional users.

It will also be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for providing customized web page content, the method comprising:
receiving information from a referring uniform resource locator (URL) including information relating to a first search performed by a user;
processing specific terms in the referring URL to produce a customized web page based upon the terms in the referring URL; and
presenting the customized web page to the user.

2. The method of claim 1, wherein the specific terms in the referring URL contains at least one search term entered by the user into a web based search engine.

3. The method of claim 2, wherein the processing specific terms further comprises:
extracting the at least one search term from the referring URL; and
searching a web site specific database for related information to the at least one search term.

4. The method of claim 3, wherein the extracting at least one search term from the referring URL further comprises dissecting the referring URL to find and isolate the at least one search term.

5. The method of claim 1, wherein presenting the customized web page to the user further comprises constructing a hypertext markup language (HTML) document specifically based upon the results of the processing specific terms in the referring URL.

6. The method of claim 5, wherein presenting the customized web page further comprises inserting both a dynamic link option as well as a listing of localized search results in the web page.

7. The method of claim 6, wherein the dynamic link option comprises a link inserted into the web page which provides the user an opportunity to perform a web site specific search based upon the specific terms in the referring URL.

8. The method of claim 7, wherein the web site specific search site further comprises searching a web site specific database for related information to the specific terms in the referring URL.

9. The method of claim 6, wherein the listing of search results is based upon a search of a web site specific database for related information to the specific terms in the referring URL.

10. A method for providing customized web page content based upon automated analysis of a referring uniform resource locator (URL), the method comprising:
receiving the referring URL including search terms relating to a first search performed by a user;
extracting the search terms from the referring URL;
searching a localized database for related information to the extracted search terms;
producing a customized web page based upon the results of the searching a localized database; and
presenting the customized web page to the user.

11. The method of claim 10, wherein the specific terms in the referring URL contains at least one search term entered by the user into a web based search engine.

12. The method of claim 10, wherein the extracting at least one search term from the referring URL further comprises dissecting the referring URL to find and isolate the at least one search term.

13. The method of claim 10, wherein producing the customized web page further comprises constructing a hypertext markup language (HTML) document specifically based upon the results of the processing specific terms in the referring URL.

14. The method of claim 10, wherein presenting the customized web page further comprises inserting both a dynamic link option as well as a listing of localized search results in the web page.

15. The method of claim 14, wherein the dynamic link option comprises a link inserted into the web page which provides the user an opportunity to perform a web site specific search based upon the specific terms in the referring URL.

16. The method of claim 15, wherein the web site specific search site further comprises searching a web site specific database for related information to the specific terms in the referring URL.

17. A system for providing customized web page content based upon automated analysis of a referring uniform resource locator (URL), the system comprising:
a user computer configured to transmit a referring URL; and
a web server configured to:
receive the referring URL including search terms relating to a first search performed by a user;
extract the search terms from the referring URL;
search a localized database for related information to the extracted search terms;
produce a customized web page based upon the results of the searching a localized database; and
transmit the customized web page to the user computer.

18. The system of claim 17, wherein the web server is further configured to construct a hypertext markup language (HTML) document specifically based upon the results of the processing specific terms in the referring URL.

19. The system of claim 17, wherein the web server is further configured to insert both a dynamic link option as well as a listing of localized search results in the web page.
